(19) United States
(12) Patent Application Publication
(10) Pub. No.: US 2024/0102643 A1
(43) Pub. Date: Mar. 28, 2024

(54) WATERPROOF LIGHTING DEVICE AND MANUFACTURING METHOD

(71) Applicant: LEDVANCE GmbH, Garching bei Munchen (DE)

(72) Inventors: Tianci Zeng, Shenzhen Guangdong (CN); Zhian LI, Shenzhen Guangdong (CN)

(21) Appl. No.: 18/370,094

(22) Filed: Sep. 19, 2023

(30) Foreign Application Priority Data
Sep. 26, 2022 (CN) 202211175106.6

(51) Int. Cl. F21V 31/00; F21S 8/04; F21V 17/10; F21V 23/00; F21V 23/06; F21V 31/03

(52) U.S. Cl. CPC F21V 31/005; F21S 8/043; F21V 17/101; F21V 23/002; F21V 23/06; F21V 31/03; F21Y 2103/10

(57) ABSTRACT

Provided are a waterproof lighting device including an optical housing, a drive box mounted beside and sealed with a housing body, and a method for manufacturing the device. The drive box is configured to control the optical housing. The optical housing includes the housing body, an end cover, and an end cover cap, and is configured to receive a light engine which is fixed and sealed in a watertight manner. Multiple mounting brackets are configured for positioning the lighting device. In accordance with the lighting device, components can be conveniently mounted and replaced, and the production of products of different lengths and specifications is ensured through an extrusion process of the present disclosure.

### CROSS-REFERENCE TO RELATED APPLICATIONS

This patent application claims the benefit of and priority to Chinese Patent Application No. 202211175106.6 filed with the China National Intellectual Property Administration on Sep. 26, 2022, which is herein incorporated by reference in its entirety.

### FIELD OF THE DISCLOSURE

The present disclosure generally relates to the technical field of lighting devices, and in particular, the present disclosure relates to a waterproof lighting device, and a method for manufacturing the device.

### BACKGROUND

The known lighting devices are provided with waterproof housings for receiving drivers and LED modules. However, these known devices are complex, and difficult to manufacture, and it is not easy to touch components of these devices, for example, for exchanging components for upgrading or maintenance.

### SUMMARY

An objective of the present disclosure is to provide a waterproof lighting device, and a method for manufacturing the device. Another objective of the present disclosure is to provide a lighting device facilitating the mounting and replacement of electrical elements.

According to a first aspect, a waterproof lighting device is provided. The waterproof lighting device includes a light engine, and an optical housing including a housing body, a first end cover at a first end of the housing body and a second end cover at a second end of the housing body. The light engine is arranged inside the optical housing. The waterproof lighting device further includes a drive box including a drive circuit for driving the light engine. The drive box is adjacent to the housing body of the optical housing, and is sealed together with the housing body in a waterproof manner. In particular, the drive box and the optical housing are mutually sealed in such a way to form two separate sealing chambers. Therefore, the drive box and the optical housing can be opened independently without breaking respective waterproof seals.

In some embodiments, the optical housing includes a first openable end cover cap fixed to the first end cover for sealing, and/or a second openable end cover cap fixed to the second end cover for sealing, especially in a watertight manner. The openable first and/or second end cover caps allow access to the interior of the optical housing, for example, for mounting or dismounting the light engine.

The first end cover cap may be fastened to the first end cover, and the second end cover cap may be fastened to the second end cover by a threaded ring and sealed with a sealing ring. In particular, each of the first end cover cap and the second end cover cap may be provided with the threaded ring, and thus the first end cover cap and the second end cover cap can be respectively locked with the first end cover and the second end cover when rotating, especially by means of a fastening tool. Due to the threaded ring, reliable fixation of the first and second end covers can be provided. With the help of the threaded sealing ring, the lighting device is waterproof.

According to some embodiments, the drive box may further include a drive box upper cover, a drive box body, and a sealing strip arranged between the drive box upper cover and the drive box body. The drive box upper cover and the drive box body can be fixed by elastic sheets. The drive box body is used to accommodate various drive box components, and the sealing strip can be compressed to achieve waterproofing.

The drive box body may include at least one, especially one or more through holes spaced from at least one corresponding through hole on an upper wall of the housing body by a sealing gasket, thus providing a sealed mechanical and/or electrical connection between the drive box and the optical housing. The sealing gasket makes the lighting equipment waterproof.

According to some embodiments, the drive box upper cover and the drive box body are fixed together using multiple drive box brackets. The bracket or clip is used to ensure that the drive box upper cover and the drive box body are tightly pressed against each other, thus providing a waterproof seal of the sealing gasket.

The drive box body and the optical housing can be fixed with multiple rivets. The rivets are provided to facilitate mounting and ensure that the drive box body and the housing are firmly fixed to each other.

According to some embodiments, the drive box and the optical housing are electrically connected to each other using a driver-to-PCB connector. The PCB connector is used to provide flexibility for quick and easy assembly. In addition, the size of the connector can vary according to the application.

According to another embodiment, one or more mounting brackets may be configured for positioning of the lighting device. The mounting bracket can be attached to the drive box, and a convenient way is provided to mount the lighting device to the ceiling, for example, using screws.

The waterproof lighting device may include a first sealed cable connector and/or a second sealed cable connector mounted in fixing hole(s) formed in one or both sides of the drive box for receiving an external power cable for power supply. The sealed cable connector particularly can provide a sealing ring to ensure that the lighting device can fixedly sealed and fixed when mounted on the ceiling.

According to some embodiments, the optical housing and the mounting bracket are inlaid together to ensure that a gap between the housing body and the ceiling is minimized.

Each of the first end cover and the second end cover may be provided with a drain hole to ensure that excess water can be drained from the housing body, thus making the lighting device waterproof and dry.

According to a second aspect, a method for manufacturing a waterproof lighting device is provided. According to the method, a light engine is provided, in particular a light engine for being mounted in a lighting device. In addition, a housing body of an optical housing for receiving the light engine is provided. The optical housing includes a first end cover at a first end of the housing body, and a second end cover at a second end of the housing body. The light engine can be mounted in the optical housing prior to mounting the first end cover and/or the second end cover. The light engine may also be mounted after the first end cover and/or the second end cover is mounted, in particular through the first openable end cover and/or the second openable end cover cap. Further, according to the method, a drive box composed of a drive box circuit, a drive box upper cover, and a drive box body is provided, which is mounted beside and sealed with the housing body of the optical housing in a waterproof manner.

The method can be used to manufacture products of different specifications, and its mold cost is relatively economical. The waterproof lighting device manufactured by the method has more reliable waterproof performance, and the wiring and parts replacement are convenient.

One of the main advantages of using the extrusion process is that the assemblies can be arranged in a distributed mode, ensuring easy mounting and replacement of electrical elements.

The foregoing summary and the following detailed description of the preferred embodiments can be better understood when read in conjunction with the accompanying numbers. However, the present disclosure is not limited to the specific assembly and method disclosed in the above numbers.

Certain portions of the this embodiment have similar components. Similar components may have the same name or similar component number. The description of one component is applicable by reference to another similar component, thereby reducing repetition of text without limiting the disclosure.

### BRIEF DESCRIPTION OF THE DRAWINGS

FIG. 1 shows a waterproof lighting device according to an embodiment;

FIG. 2 schematically shows a waterproof lighting device according to FIG. 1, where the mounting bracket is separated from a drive box;

FIG. 3 schematically shows an exploded view of a waterproof lighting device according to one embodiment;

FIG. 4 schematically shows a mounting process of a waterproof lighting device according to one embodiment;

FIG. 5 schematically shows a detailed exploded view of a waterproof lighting device of FIG. 1;

FIG. 6 schematically shows a detailed view of an electrical connection of a waterproof lighting device according to FIG. 1;

FIG. 7 schematically shows a drive box internally provided with various components according to some embodiments;

FIG. 8 schematically shows a waterproof lighting device according to one embodiment, where a drive box upper cover and a drive box body are fixed through a drive box bracket.

FIG. 9 schematically shows a waterproof lighting device according to one embodiment, where a drive box upper cover and a drive box body are sealed with a sealing gasket;

FIG. 10 schematically shows a waterproof lighting device according to one embodiment, where an end cover and an end cover cap are locked through a sealing ring to achieve waterproofness;

FIG. 11(a) and FIG. 11(b) schematically show a waterproof lighting device according to one embodiment, where an end cover cap is smaller than the end cover, so as to facilitate the mounting and replacement of a light engine;

FIG. 12 shows a waterproof lighting device according to another embodiment, where a drive box is mounted near an optical housing;

FIG. 13 schematically shows a detailed view of a waterproof lighting device of FIG. 12;

FIG. 14 schematically shows a mounting process of a waterproof lighting device according to one embodiment;

FIG. 15 schematically shows a detailed view of a waterproof lighting device according to one embodiment, where a drive box is mounted near an optical housing, so as to facilitate the replacement of electric elements;

FIG. 16 schematically shows a replacing process of a light engine in a waterproof lighting device according to one embodiment;

FIG. 17 schematically shows a waterproof lighting device according to one embodiment;

FIG. 18 schematically shows a perspective view and a front view of a waterproof lighting device according to one embodiment, where an optical housing and a mounting bracket are inlaid together for positioning the lighting device;

FIG. 19 schematically shows a waterproof lighting device according to one embodiment, where a drive box body and an optical housing are sealed with rivets and fixed together.

### DETAILED DESCRIPTION

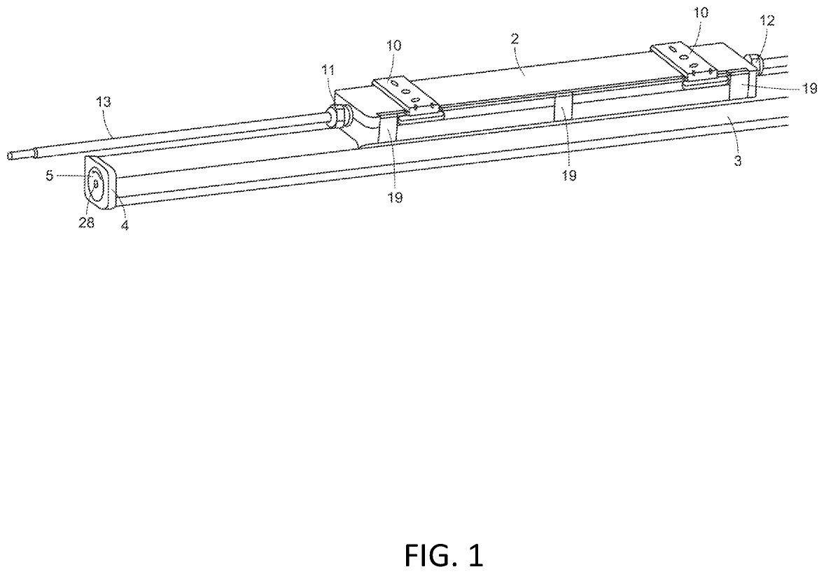

FIG. 1 shows a waterproof lighting device according to one embodiment. The lighting device 1 includes a drive box 2, and an optical housing 3. The drive box 2 is mounted on the optical housing 3. According to a first embodiment, the drive box 2 is mounted outside and on the optical housing 3. The drive box 2 includes an upper cover and a lower body which are pressed by a drive box bracket 19 or a clip. A driver and other electrical elements (not shown in FIG. 1) are placed in a driver box 2, and the entire lighting device 1 or lamp can be mounted through a mounting bracket 10. In the shown arrangement of the drive box 2 outside the optical housing 3, an electrical kit 29 may be laid flatly in the drive box 2. In addition, the replacement of the electrical kit 29 is more convenient, this is because the drive box 2 can be easily opened by separating the upper cover from the lower body, instead of being mounted one by one like an extrusion drive box 2. An elastic sheet on the drive box 2 can be easily opened for external wiring or electrical element replacement. An end cover cap can be opened for replacing a light engine 9, in particular a light-emitting diode (LED) light engine, an LED unit, or the combination of the LED unit and other light units.

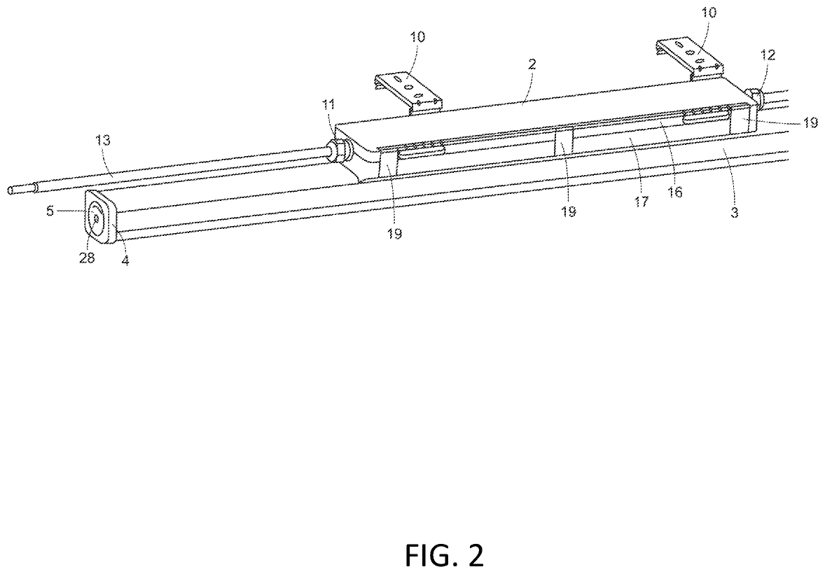

FIG. 2 schematically shows a waterproof lighting device according to FIG. 1, where the mounting bracket is separated from the drive box 2. FIG. 2 illustrates in particular that the mounting bracket can be mounted separately from the drive box 2, thus facilitating the mounting of the lighting device 1 on the ceiling.

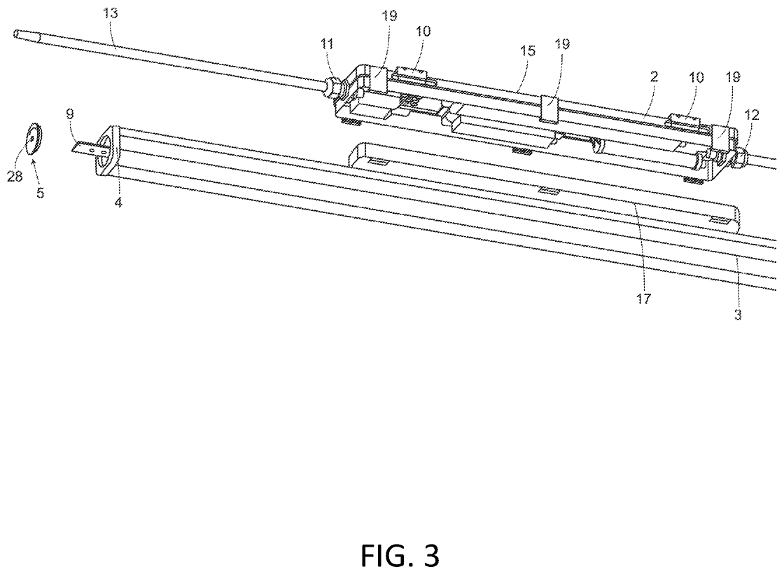

FIG. 3 schematically shows an exploded view of a waterproof lighting device according to one embodiment. As can be seen from FIG. 3, the lower body of the drive box 2 is mounted on the optical housing 3 from the outside. Due to the separation of the drive box 2 and the optical housing 3, the optical housing can be kept simple and can be easily manufactured through an extrusion process. In addition, a matching contact surface of an extrusion member is smaller than that of a product processed by injection molding. The extrusion process described in detail in the present disclosure has the characteristics that the same set of molds can be used to produce products of different lengths and specifications, especially the optical housing of a lighting appliance, so the production cost is low. Moreover, the matching contact surface of the extrusion part is smaller than that of the injection molded product, so the waterproof effect is easy to achieve and the reliability is high. Such a design makes full use of the above characteristics of the extrusion process. In this embodiment, the optical housing 3 is configured to receive the light engine 9 in the housing body, and includes a first end cover 4 at a first end of the housing body and a second end cover 6 at a second end of the housing body. The first end cover 4 is fastened to the housing body and sealed with a first end cover cap 5, and the second end cover 6 is fastened to the housing body and sealed with a second end cover cap 7 in a watertight state. As detailed in the drawings, the drive box 2 can be conveniently opened for external wiring/mounting of electrical elements. The end cover caps 5 and 7 (the latter not shown) can be opened to facilitate the replacement of the light engine 9.

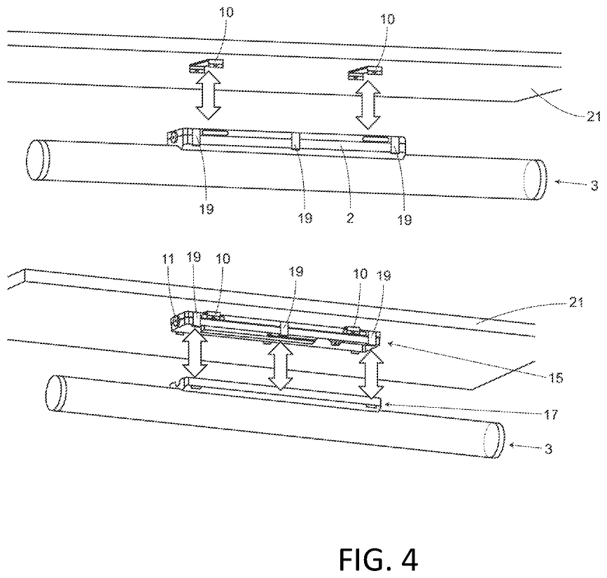

FIG. 4 schematically shows a mounting process of a waterproof lighting device according to one embodiment. In the embodiment of FIG. 4, the drive box 2 is mounted beside the optical housing 3 manufactured by an extrusion process, thus facilitating the mounting and replacement of electrical elements. The drive box 2 mounted on the optical housing 3 can be mounted on the ceiling 21 and dismounted using a mounting bracket 10. The drive box bracket 19 is used to fix a drive box upper cover and a drive box body 17. At the time of replacement, the drive box body 17 can be conveniently dismounted from the drive box upper cover 15 attached to the ceiling 21, as shown in the drawings.

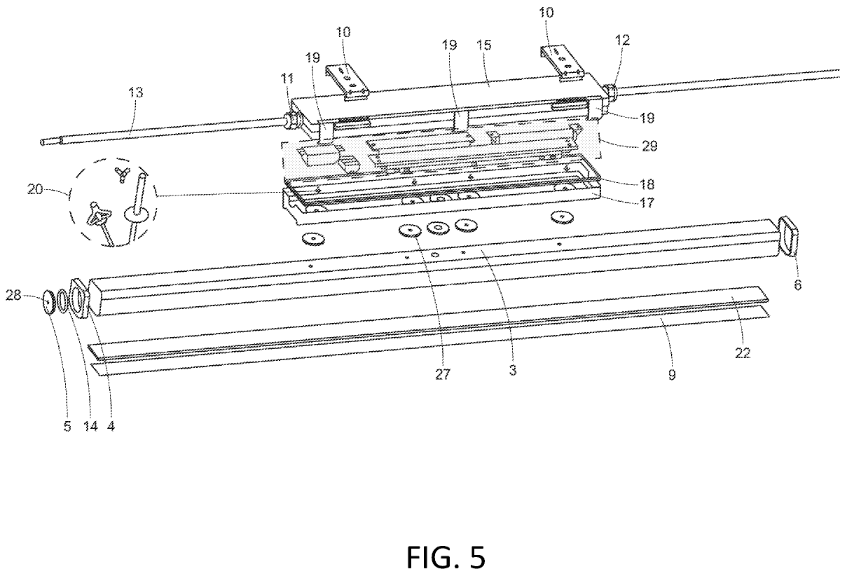

FIG. 5 schematically shows a detailed exploded view of a waterproof lighting device of FIG. 1. In particular, FIG. 5 shows components of the lighting device 1 in more detail. The drive box 2 includes a driver 24, and other electrical components as a part of the electrical kit 29, such as an emergency kit 25, a battery 26, etc., which are housed in the drive box body 17 or encapsulated in the drive box upper cover 15 and the drive box body 17 or a lower cover. In this embodiment, the drive box body 17 and the optical housing 3 are fixed with multiple rivets 20.

The mounting bracket 10 is configured on the drive box 2 for positioning the lighting device 1. In some embodiments, the drive box 2 also includes a first cable connector 11 and/or a second cable connector 12 mounted in fixing holes respectively formed in both sides of the drive box 2 for receiving external power cables 13 for power supply. The optical housing 3 further includes a first end cover 4 and a second end cover 6 as well as a first end cover cap 5 and a second end cover cap 7. Contact surfaces of the end cover caps 5 and 7 are smaller than those of the end covers 4 and 6 to ensure waterproof performance and facilitate the mounting and/or replacement of the light engine 9. In addition, the size of the end cover cap is smaller to ensure that the lighting device is easier to seal. The first end cover 4 and the second end cover 6 are glued to the housing body 3, or the first end cover 4 and the second end cover 6 are mounted on a heat sink 22.

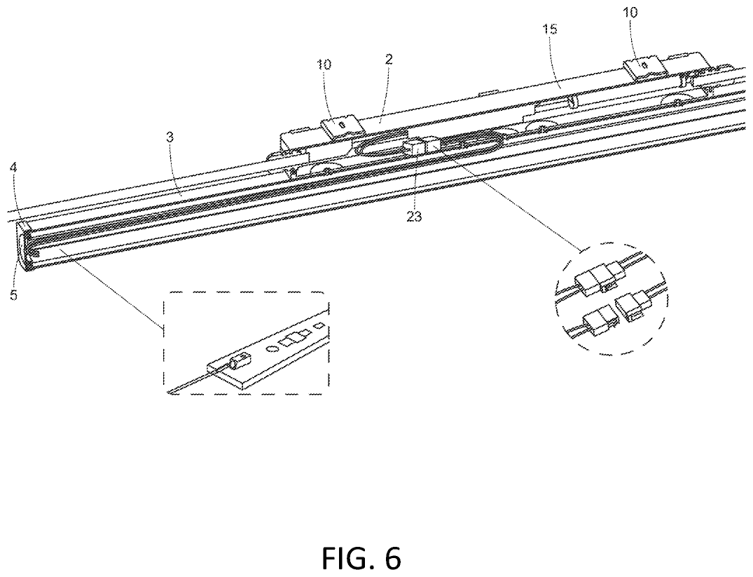

FIG. 6 schematically shows a detailed view of an electrical connection of a waterproof lighting device according to FIG. 1. As can be seen from FIG. 6, the drive box 2 or the drive circuit is connected to the optical housing 3 or the light engine 9 through a driver-to-PCB connector 23. As shown in an enlarged view at a lower right corner of FIG. 6, the driver-to-PCB connector 23 is used to provide flexibility for quick and easy assembly. In addition, the size of the connector can vary according to the application. As shown in the lower left corner of FIG. 6, a printed circuit board of light engine 9 is connected to the wiring through a surface mount device (SMD) connector. The connector concept can make the electrical connection between components simple and fast.

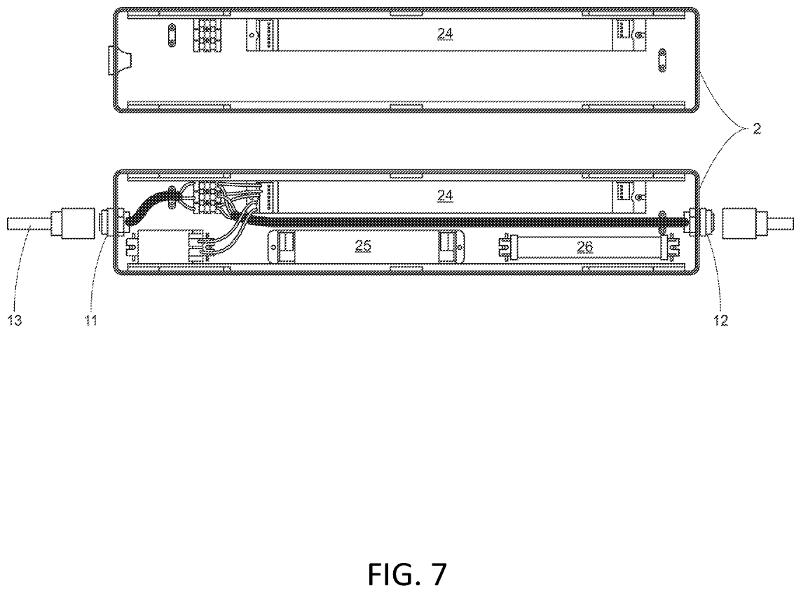

FIG. 7 schematically shows a drive box internally provided with various components according to some embodiments. According to embodiments shown in the lower part of FIG. 7, the drive box 2 includes a driver 24, an emergency kit 25, and a battery 26 which are connected in a distributed mode to facilitate insertion and replacement of the aforementioned components. Depending on the application, the drive box 2 can also accommodate other components. The lighting device 1 can be configured according to different specifications, and its mold cost is relatively economical.

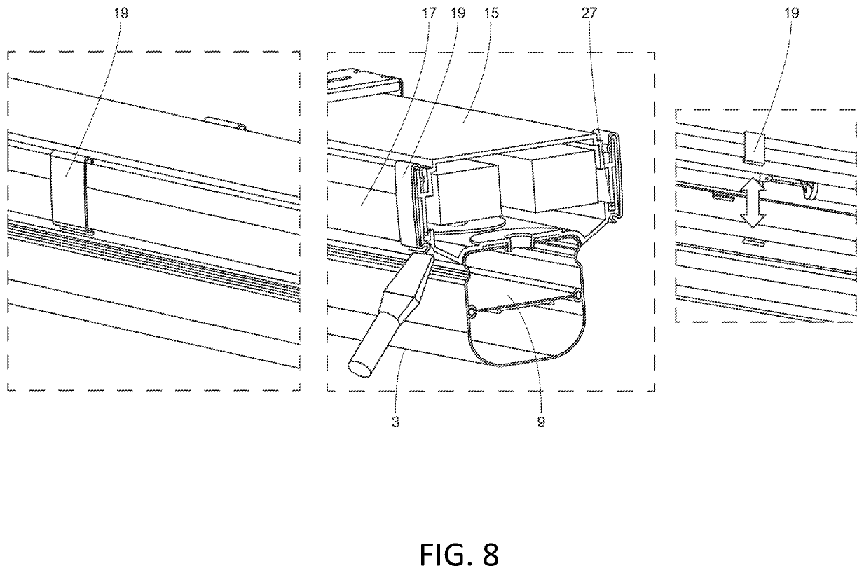

FIG. 8 schematically shows a waterproof lighting device according to one embodiment, where the drive box upper cover and the drive box body are fixed through a drive box bracket or a clip. The bracket 19 or the clip ensures that above drive box components are positioned and fixed within the drive box 2, and the drive box 2 is mounted near the optical housing 3. The bracket 19 or clip can be easily opened with a hand tool such as a screwdriver.

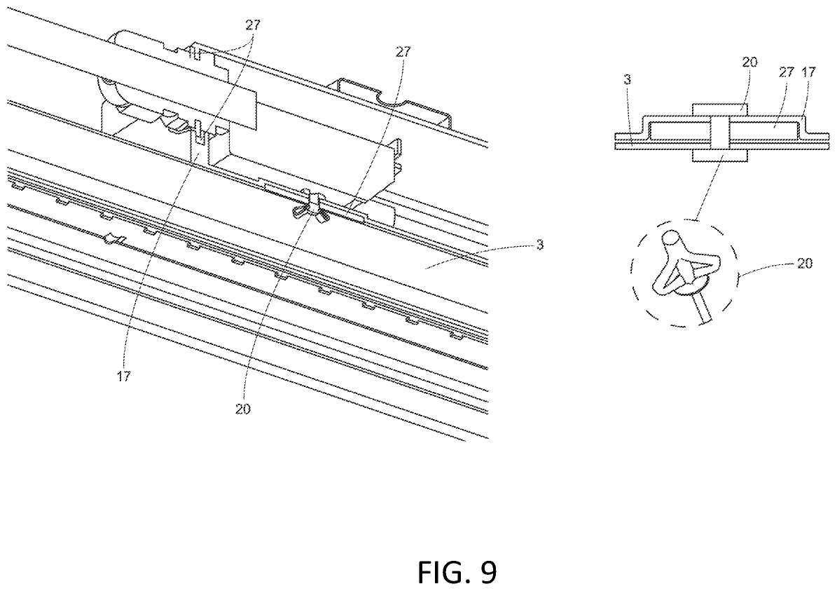

FIG. 9 schematically shows a waterproof lighting device according to one embodiment, where the drive box upper cover and the drive box body are fixed and sealed with a sealing gasket. The gasket 27 is arranged between the drive box body 17 and the optical housing 3 to make the lighting device 1 waterproof. As shown in FIG. 5, a sealing strip 18 is arranged between the drive box upper cover 15 and the drive box body 17 or the lower cover, and the outside of the cover is fixed with an elastic sheet. A gasket 27 is arranged between the drive box body 17 and the optical housing 3, which are fastened and fixed by multiple rivets 20. The cable connector is sealed with a sealing ring. Two separate chambers of the driver 24 and the light engine 9 are sealed to each other.

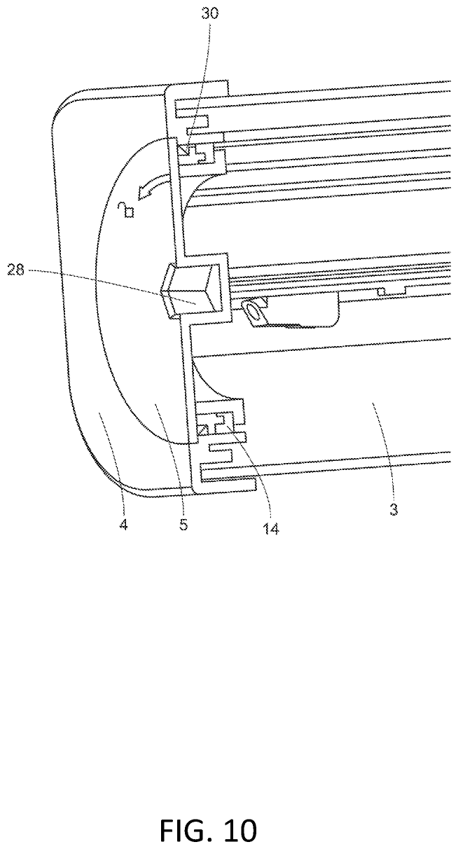

FIG. 10 schematically shows a waterproof lighting device according to one embodiment, where an end cover and an end cover cap are locked through a threaded sealing ring 14 to achieve waterproofness. The first end cover cap 5 is locked with the first end cover 4, the second end cover cap 7 is locked with the second end cover 6, and when a locking structure 30 rotates, the sealing is achieved by a threaded end cover cap 5 with the sealing ring 14. As shown in the drawings, there is a sealing ring 14 in the middle, and when the cover is locked, the sealing strip 18 is compressed to achieve waterproofing. The first end cover 4 and the second end cover 6 are bonded with the optical housing 3 by an adhesive such as glue. In some embodiments, the seal may also include a gasket.

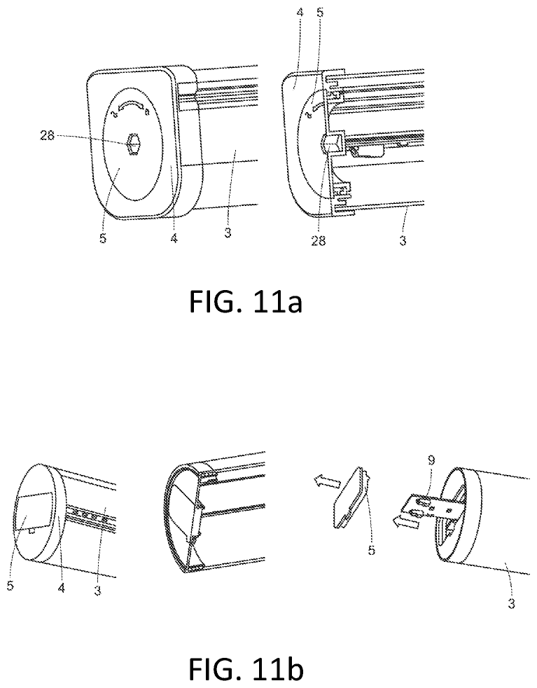

FIG. 11(a) and FIG. 11(b) schematically show a waterproof lighting device according to one embodiment, where the end cover cap is smaller than the end cover, so as to facilitate the mounting and replacement of the light engine. In a preferred embodiment of the present disclosure, end faces of the optical housing 3 are provided with a first end cover 4 and a second end cover 6, respectively, and the end cover is further provided with an end cover cap. The size of the first end cover cap 5 is smaller than that of the first end cover 4, and the size of the second end cover cap 7 is smaller than that of the second end cover 6. The end cover caps 5 and 7 are tightly locked and mated with the end covers 4 and 6 by fastening tools such as buckles, threads or screws. As described above, a sealing ring 14 is arranged between the one end cover and the corresponding end cover cap. After the respective small end cover caps 5 and/or 7 are opened, the light engine 9 can be mounted, dismounted or replaced. The end covers 4 and/or 6 may be attached to the optical housing 3 by an adhesive such as glue, or the end covers may be mounted on the heat sink 22. A sealing ring 14 may be added outside the housing body and/or the end covers 4, 6, such that the end covers can move freely to absorb the thermal expansion experienced by different materials when the temperature changes.

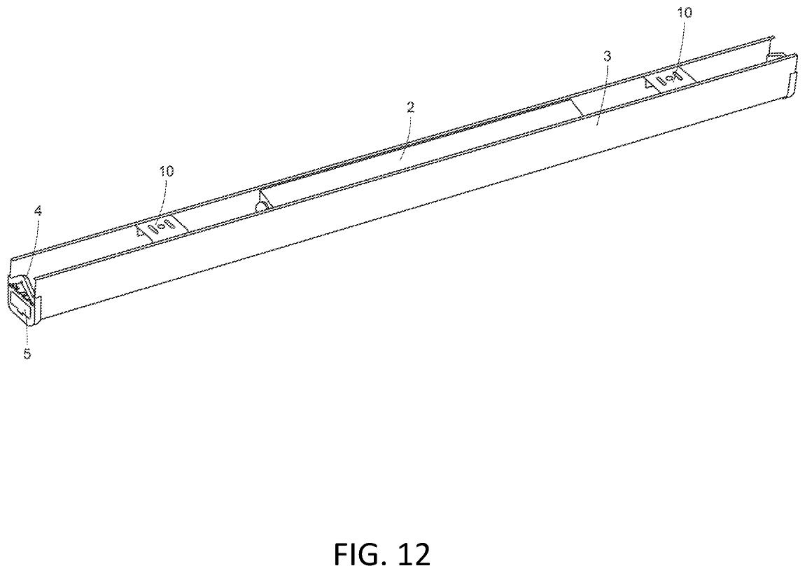

FIG. 12 shows a waterproof lighting device according to another embodiment, where the drive box is mounted beside the optical housing. The lighting device 1 is provided with multiple inlaid mounting brackets 10 which are configured for positioning the lighting device 1.

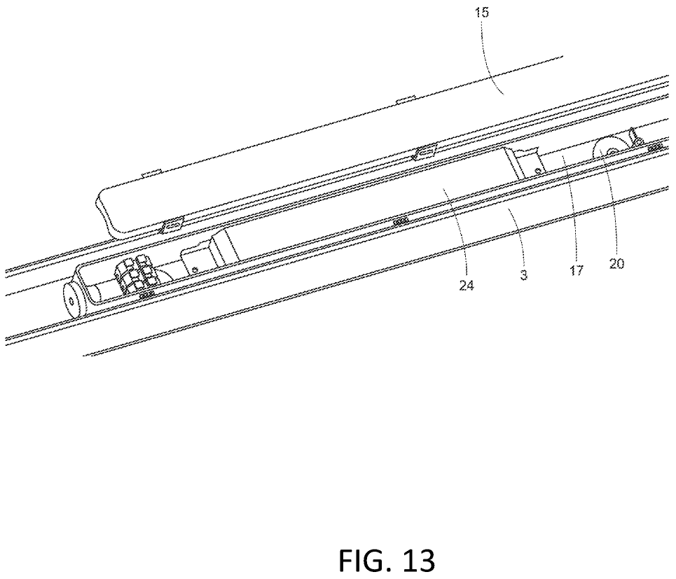

FIG. 13 schematically shows a detailed view of a waterproof lighting device of FIG. 12. The drive box 2 is mounted beside the optical housing 3 produced through an extrusion process. As a matching contact surface of an extrusion member is smaller than that of an injection molded product, the waterproof effect is easy to achieve, and the reliability is high. Even in the above embodiments, the end cover cap (not shown) can be opened to replace the light engine 9.

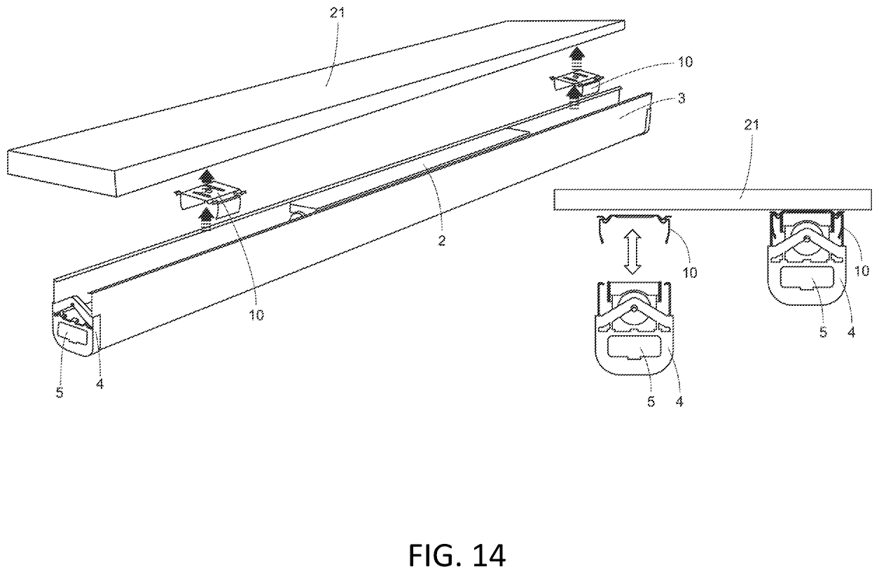

FIG. 14 schematically shows a mounting process of a waterproof lighting device according to one embodiment. The drive box 2 is mounted beside the optical housing 3 manufactured through an extrusion process. As can be seen from FIG. 14, the lighting device can be easily mounted through multiple mounting brackets 10. Each mounting bracket 10 can be easily attached to the ceiling 21, for example, using screws. In general, the mounting bracket 10 is fixed to a lamp box by screws, and the lamp is connected to the bracket by machine screws or by threaded posts screwed into threaded holes at the center of the mounting bracket. The brackets may be simple flat strips with screw slots, but some are adjusted by sliding, while others are slightly offset to provide a relatively more space for electrical connection. A two-step process is described in detail in the drawing to facilitate the attachment of the optical housing 3 accommodating the drive box 2. In the first step, the mounting bracket 10 is mounted to an ideal position of the ceiling 21, and in the subsequent step, the lighting device 1 is mounted to the mounting bracket 10. After the mounting bracket is mounted and fixed to the ceiling 21, the drive box 2 can be connected to a main power supply before mounting the lighting device 1. According to different embodiments, the lighting device 1 may be mounted to the ceiling by mounting the drive box 2 and/or the optical housing 3 to the mounting bracket 10.

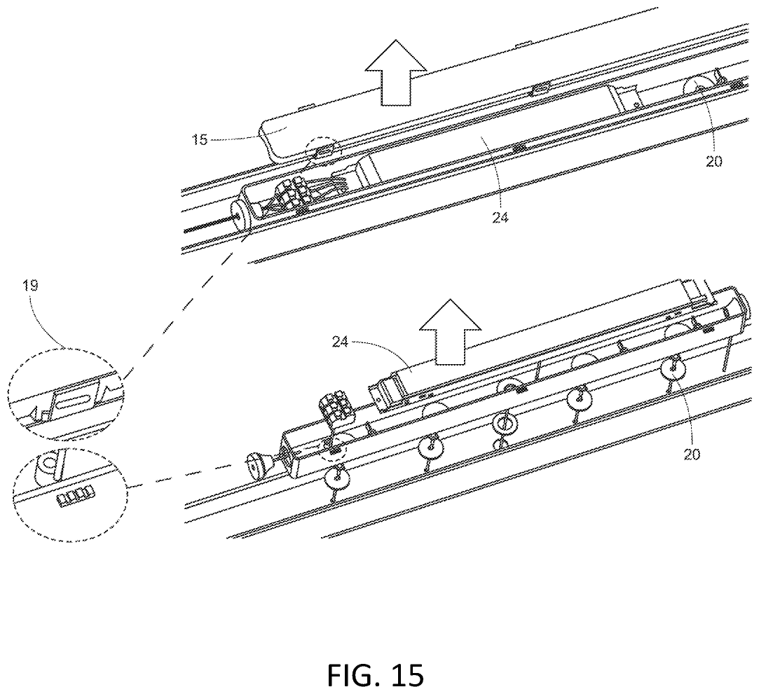

FIG. 15 schematically shows a detailed view of a waterproof lighting device according to one embodiment, where the drive box 2 is mounted beside the optical housing 3 manufactured through an extrusion process, so as to facilitate the replacement of electric elements. As an illustration, the replacement of a driver 24 by opening the drive box upper cover 15 is described in detail. The drive box body 17 and the optical housing 3 are fixed together with multiple rivets 20.

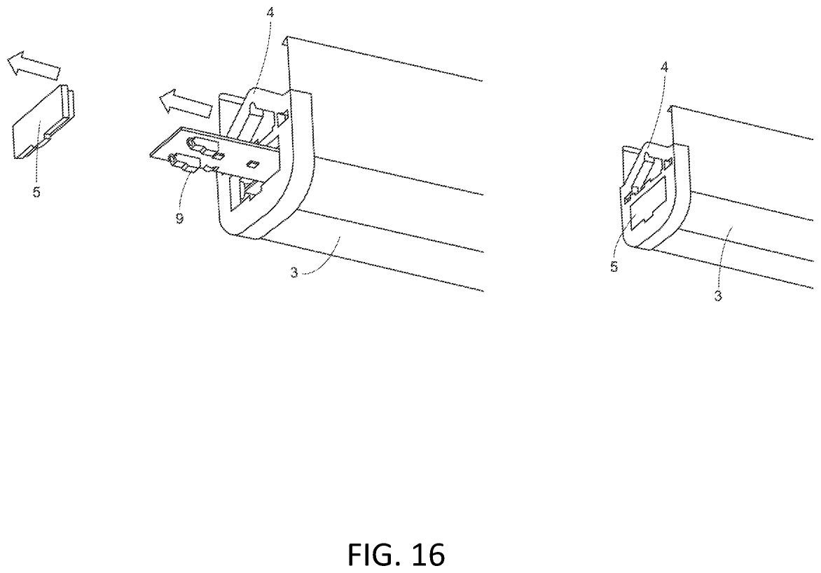

FIG. 16 schematically shows a process of replacing a light engine in a waterproof lighting device according to one embodiment, where the drive box 2 is mounted beside the optical housing 3 manufactured through an extrusion process. By opening the end cover cap 5 or 7, the light engine 9 can be easily replaced or dismounted through the end cover 4 or 6, as detailed in the drawings.

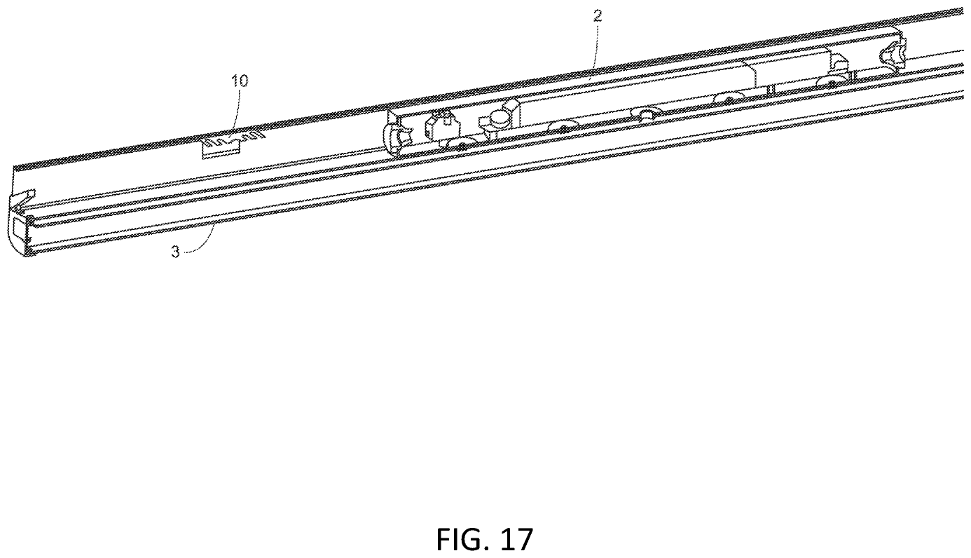

FIG. 17 schematically shows a waterproof lighting device according to one embodiment. The drive box 2 is mounted beside the optical housing 3 and is electrically connected through a driver-to-PCB connector 23. The PCB connector is used to provide flexibility for quick and easy assembly. In addition, the size of the connector can vary according to the application.

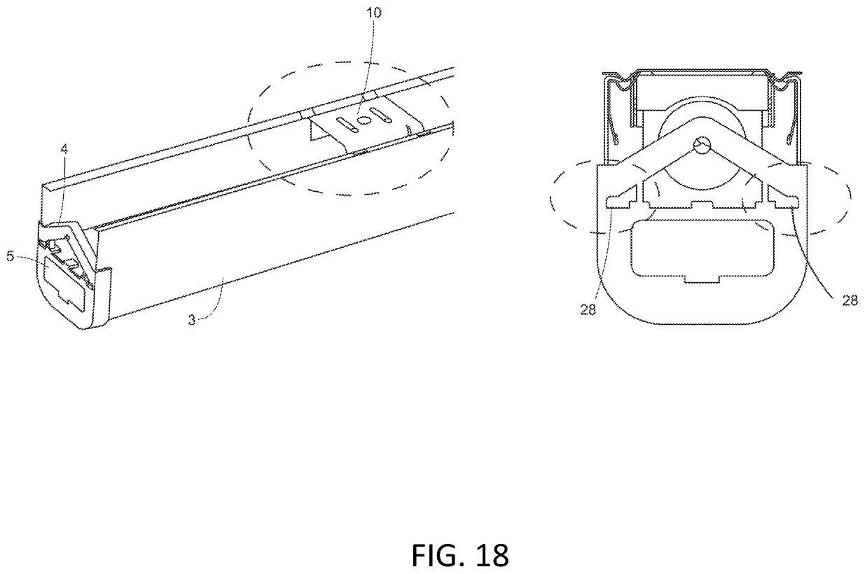

FIG. 18 schematically shows a perspective view and a front view of a waterproof lighting device according to one embodiment, where the optical housing 3 and the mounting bracket 10 are inlaid together for positioning the lighting device 1. After assembly, a gap between the housing body and the ceiling 21 is tiny, but may cause irregularities or foreign objects on the ceiling. In the embodiment, the end cover is provided with a drain hole, as described in detail in the drawing. If there is water in the housing body, the water can be drained in time to avoid the harmful effects of accumulated water in the housing body.

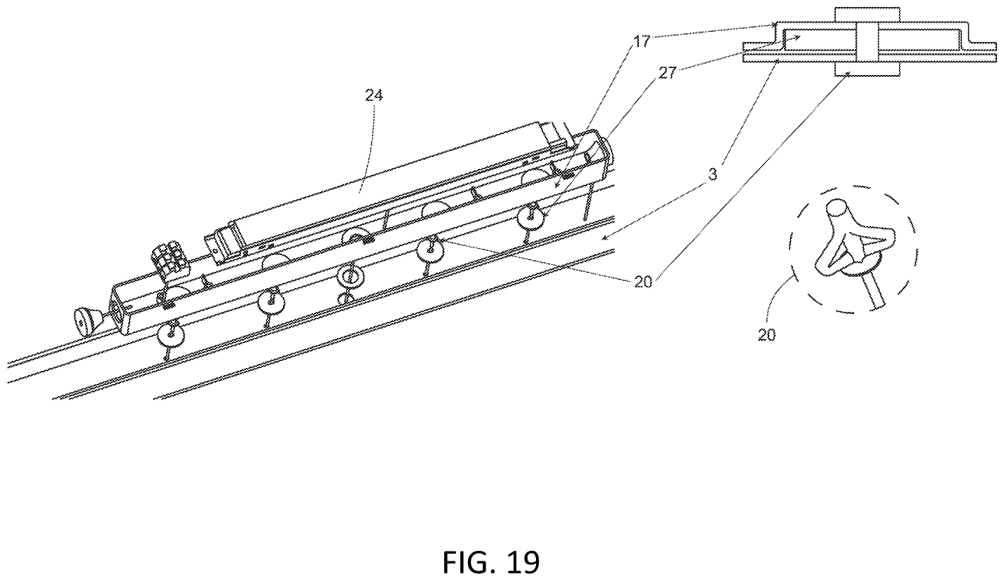

FIG. 19 schematically shows a waterproof lighting device according to one embodiment, where the drive box 2 is mounted beside the optical housing 3, and the drive box body 17 and the optical housing 3 are fixed and sealed with the rivets 20 and fixed together. The rivets can be conveniently mounted to ensure that the drive box is firmly attached to the optical housing 3. Due to the above mounting concept with mounting bracket, the gap between the lighting device and the ceiling is small.

The lighting device can be easily manufactured. In particular, the housing body of the optical housing can be manufactured by an extrusion process. The extrusion process is cost-effective, and a length of the optical housing can be flexibly selected. In contrast, if the product is processed through an injection molding process, the electrical components are placed in the housing body, and the housing body can be opened, but a set of mold tools needs to be added for each different length, leading to high investment cost. On the other hand, the drive box can be manufactured through an injection molding process, such that the drive box can be easily obtained when replacing the drive components. On the contrary, if the product is processed by the extrusion process, the electrical components can be placed inside. However, due to limited channel, the assembly and dismounting are difficult. In addition, more configurations, such as intelligent modules and emergency modules, cannot be mounted. Therefore, the lighting device can combine the advantages of two manufacturing technologies, the optical housings of different lengths can be conveniently manufactured, and the accessibility of conveniently dismounting or replacing parts and/or components is achieved.

Although at least two demonstrative embodiments have been proposed in the foregoing detailed description, it should be understood that there are numerous variations. It should also be understood that the demonstrative embodiments are only examples and are not intended in any way to limit the scope applicability or configuration of the present disclosure. On the contrary, the above detailed description will provide a convenient route map for those skilled in the art to implement demonstrative embodiments.

What is claimed is:

1. A waterproof lighting device comprising:
a light engine;
an optical housing comprising:
a housing body;
a first end cover at a first end of the housing body; and
a second end cover at a second end of the housing body, wherein a light engine is arranged in the optical housing; and
a drive box comprising a drive circuit configured for driving the light engine, wherein the drive box is mounted beside and sealed with the housing body in a waterproof manner.

2. The waterproof lighting device according to claim 1, wherein the optical housing comprises at least one of:
a first openable end cover cap fastened to the first end cover for sealing; and
a second openable end cover cap fastened to the second end cover for sealing.

3. The waterproof lighting device according to claim 2, wherein:
the first end cover cap is fastened to the first end cover by a first threaded ring and is sealed with a first sealing ring; and
the second end cover cap is fastened to the second end cover by a second threaded ring and is sealed with a second sealing ring.

4. The waterproof lighting device according to claim 1, wherein the drive box further comprises:
a drive box body;
a drive box upper cover configured to be fixed to the drive box body; and
a sealing strip arranged between the drive box upper cover and the drive box body.

5. The waterproof lighting device according claim 4, wherein the drive box body comprises at least one through hole separated by a sealing gasket from at least one corresponding through hole on an upper wall of the housing body, wherein the at least one through hole provides at least one of a sealed mechanical connection and an electrical connection between the drive box and the optical housing.

6. The waterproof lighting device according to claim 4, wherein the drive box upper cover and the drive box body are fixed together using a plurality of drive box brackets.

7. The waterproof lighting device according to claim 4, wherein the drive box body and the optical housing are fixed using a plurality of rivets.

8. The waterproof lighting device according to claim 1, wherein the drive box and the optical housing are electrically connected to each other using a driver-to-printed circuit board (PCB) connector.

9. The waterproof lighting device according to claim 1, further comprising one or more mounting brackets configured for positioning the lighting device.

10. The waterproof lighting device according to claim 1, further comprising one or more sealed cable connectors mounted in a fixing hole formed on one side or both sides of the drive box and configured for receiving an external power cable configured for power supply.

11. The waterproof lighting device according to claim 9, wherein the optical housing and the one or more mounting brackets are inlaid together.

12. The waterproof lighting device according to claim 1, wherein each of the first end cover and the second end cover has formed therein a drain hole configured to drain excess water from the housing body.

13. A method for manufacturing a waterproof lighting device, the method comprising:
providing a light engine;
providing a housing body of an optical housing configured for receiving the light engine, wherein the optical housing comprises:
a first end cover at a first end of the housing body; and
a second end cover at a second end of the housing body;
providing a drive box comprising:
a drive box body;
a drive box upper cover; and
a drive circuit disposed within the drive box and configured for driving the light engine;
mounting the drive box beside the housing body of the optical housing; and
sealing the drive box with the optical housing in a waterproof manner.
